(19) United States
(12) Patent Application Publication
(10) Pub. No.: US 2009/0017306 A1
(43) Pub. Date: Jan. 15, 2009

(54) HYDROPHILIC HARD COAT FILMS

(75) Inventors: Karlheinz Hildenbrand, Krefeld (DE); Peter Capellen, Krefeld (DE); Eberhard Koch, Burscheid (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/171,585

(22) Filed: Jul. 11, 2008

(30) Foreign Application Priority Data
Jul. 14, 2007 (DE) 102007032886.0

(51) Int. Cl. B32B 27/36; B32B 17/06; B32B 17/10; C08F 2/48; B29C 71/04

(52) U.S. Cl. 428/412; 427/508; 428/426; 428/430; 428/480; 522/71

(57) ABSTRACT

The invention concerns a composition containing a) colloidal silica; b) an acrylate; c) a protic solvent; d) a photoinitiator; and e) an anionic sulfur-containing surfactant, the use of the composition for coating substrates, and substrates coated with such formulations.

### CROSS-REFERENCE TO RELATED APPLICATIONS

This application claims benefit to German Patent Application No. 10 2007 032 886.0, filed Jul. 14, 2007, which is incorporated herein by reference in its entirety for all useful purposes.

### BACKGROUND OF THE INVENTION

The invention concerns a composition comprising a) colloidal silica; b) an acrylate; c) a protic solvent; d) a photoinitiator system; and e) a singly-charged, anionic sulfur-containing surfactant, the use of the composition for coating substrates, and substrates coated with such formulations.

In comparison to conventional acrylate systems, the surface of UV-cured hard coat films is hydrophilic and SiOH-functional and is thus an ideal surface for further coatings, in particular for cationic agents from aqueous solution.

The principle of improving the properties of coatings by integrating silica has long been known. By adding silica particles, coatings can be improved in terms of, for example abrasion, scratch resistance, reflective properties, gloss, antistatic properties, flammability, UV resistance, antifogging properties, wettability with water and chemical resistance. If silica is used in the form of nanoparticles (particle sizes less than 100 nm), it should be possible to achieve these property improvements while retaining or only slightly reducing the transparency.

Thus, in the past, there has been no shortage of attempts to provide silicon dioxide-containing coating compositions having further improved overall properties with regard to the above features.

DE 103 11 639 A1 describes antistatic molded articles and a process for their production. In order to achieve this object, coating systems consisting of acrylate-containing binders, alcoholic solvents, nanoscale electrically conductive metal oxides, nanoscale inert particles such as silicon dioxide and optionally further additives such as dispersing aids, for example, are described. The average particle size of the inert nanoparticles used is 2 nm to 100 nm, these being used in contents of 0.1 mass % to 50 mass %, based on the dry film.

JP 61-181809 discloses UV-curable compositions for coatings having good adhesion properties and high abrasion resistance comprising α,β-unsaturated carboxylic acids and colloidal silicon dioxide particles, dispersed in water or lower-valency alcohols.

JP 2005-179539 describes antifogging coatings comprising 20 wt. % to 99 wt. % of a mixture consisting of 0 wt. % to 80 wt. % of fine-scale particles, for example silicon dioxide, and 100 wt. % to 20 wt. % of a plastic, and 0.5 wt. % to 30 wt. % of a sulfosuccinate having two anionic substituents.

Coating compositions based on polyfunctional acrylic acid esters for producing coatings with high transparency, weathering resistance and scratch resistance are described in EP 0 050 996. In addition to the cited acrylic acid derivatives, the compositions contain a polymerization initiator and inorganic fillers such as silicon dioxide having average particle diameters of between 1 nm and 1 μm and a refractive index of 1.40 to 1.60.

U.S. Pat. No. 4,499,217 describes anhydrous coating compositions consisting of colloidal silicon dioxide having average particle diameters of 10 μm to 50 μm and thermally curing compounds, such as acrylic compounds. The cured coatings display good abrasion resistance and good adhesion to substrates.

JP 2001-019874 discloses compositions comprising (poly)ethylene glycol (poly)methyl methacrylate, acrylamides, photoinitiators, dispersing aids and silica for producing coatings having high adhesion and elevated scratch resistance.

WO 2006049008 describes a hydrophilic coating based on silica particles, which are suspended in a high-boiling solvent, such as N,N-dimethylacetamide, mixed with an alcoholic solution of a non-ionic surfactant (L-77) and then conditioned for 10 minutes at 100° C. The coating leads to a hydrophilic surface, with water contact angles of 20° or less being achievable. This process is used for coating spectacle lenses to give them antifogging properties. However, these conditions are unsuitable for coatings of plastic substrates because of their sensitivity to the solvents used here.

A casting formulation consisting of a mixture of an organic solution of polyvinyl butyral and an alcoholic suspension of colloidal silica is described in U.S. Pat. No. 4,383,057. In terms of solids, the composition can consist of 20 wt. % to 95 wt. % of polyvinyl butyral and 80 wt. % to 5 wt. % of silica. With a view to improving stability values, such as scratch resistance, chemical resistance and flammability, the polyvinyl butyral polymer is crosslinked, using alkyl ether-modified methylol melanines, for example. No further details are given of surface properties, such as hydrophilicity or water contact angle. Furthermore, although these coatings are described as transparent, no quantitative details, such as haze values, are provided.

In Langmuir, 6048-6053 vol. 21, 2005 the production of transparent silicon dioxide/polymethyl methacrylate nanocomposites by the polymerization of microemulsions with addition of dispersing aids is described. The use of sodium bis-(2-ethylhexyl)sulfosuccinate as an ionic surfactant is also disclosed. It has been found in this case, however, that after polymerization, this surfactant, like all conventionally used ionic dispersing aids, leads to a loss of transparency in the nanocomposite obtained.

If, as described in WO 2006048277, surfaces having particularly high and dense silica structures are to be produced, the silica is commonly deposited locally by means of flame hydrolysis from silica precursors, for example from hexamethyl disilazane or tetraethoxysilane. The hydrophobic character of these coatings can be further strengthened by the integration of fluoroalkyl silanes.

EP 337 695 discloses silicon dioxide dispersions for the abrasion-resistant coating of solid, in particular transparent substrates. The dispersions contain colloidal silicon dioxide having particle sizes of less than 100 nm, preferably less than 75 nm, particularly preferably less than 50 nm, dispersed in a protically substituted ester or amide of an acrylic or methacrylic acid. 0.1 to 2.5 parts by weight of silicon dioxide per part by weight of unsaturated monomer used are used in this case. The dispersions can be cured by UV radiation on suitable substrates after addition of a photoinitiator.

As described in Examples 2 to 4 of EP 337 695, the abrasion (abrasion test with Taber abraser model 503) of acrylate formulations can be improved by the addition of silica nanoparticles. While in the case of unfilled acrylate systems (100% PETA/0% silica) a % haze value of 23.1 was obtained after 1000 cycles, the values for a ratio of 66.6% PETA to 33.3% silica and 50% PETA to 50% silica are 18 and 8.1 respectively. With higher silica contents, the abrasion value deteriorates markedly, however. For instance, with an acrylate (PETA)/silica ratio of 33.3 to 66.6, an abrasion value of 10.1 (% haze after 1000 cycles) is obtained. Correspondingly, in EP 337 695 the best product properties were obtained with an acrylate/silica ratio of around 1:1. However, in view of the desired objectives, namely hydrophilic hard coat films with high affinities to aqueous cationic agents, higher silica contents with no deterioration in abrasion values would be of great interest.

An object of the present invention is therefore the provision of hydrophilic hard coat systems which have very good abrasion values combined with low haze and which adhere very well to various substrates. The haze, determined from the haze values as defined in ASTM 1003-00, should be less than 1%, preferably less than 0.6%. The abrasion values, determined in accordance with ASTM 1003-00, should be less than 12% after 1000 cycles, preferably less than 8%. The adhesion, determined in accordance with ASTM D 3359, should have ISO ratings of less than 2, preferably less than 1.

Particularly in the case of hard coat films having hydrophilic surface properties and displaying the range of properties in accordance with the object of the invention, there is also an elevated need for the provision of suitable formulations having a silica content which is well above the content of acrylate used.

Moreover, these surfaces should be suitable as a primer layer for further coatings, in particular from aqueous solutions containing cationic agents, for example.

The formulations according to the invention should be able to be applied to the individual substrates by means of simple technologies, such as dipping, spraying or flow coating.

Surprisingly it was found that such formulations can be produced from silica-containing, UV-curable acrylate systems in combination with at least one anionic, sulfur-containing surfactant.

### SUMMARY OF THE INVENTION

The present invention therefore concerns a composition comprising:

a) colloidal silica;
b) at least one acrylate;
c) at least one protic solvent;
d) at least one photoinitiator; and
e) at least one, anionic sulfur-containing surfactant.

The present invention also relates to a process for producing the composition, comprising:
i) producing a suspension containing colloidal silica;
ii) mixing the acrylate b), the photoinitiator d), the protic solvent c) and an anionic sulfur-containing surfactant e) together in the absence of light;
iii) mixing the suspension from i) and the mixture from ii) together in the absence of light.

### DETAILED DESCRIPTION OF THE PREFERRED EMBODIMENTS

Surprisingly it was found that the compositions according to the invention make it possible to obtain very good product properties in the coated product.

Component a), colloidal silica, generally comprises protonated, alcohol-compatible silicon dioxide nanoparticles or silica nanoparticles having an acid pH. In particular, it comprises spherical SiO₂ particles with diameters of 1 nm to approximately 100 nm, wherein particles having particle sizes of less than 50 nm are preferably used, particularly preferably less than 30 nm.

Such products are produced by various manufacturers in a variety of media. The corresponding aqueous, alkali-stabilized nanoparticle suspensions, which are sold for example under the product names Levasil®, Ludox® or Nalco®, are very accessible. However, the purely aqueous, alkali-stabilized products which generally have pH values of 9 to 10, are not suitable for the coating formulations according to the invention. For one thing the aqueous suspensions are incompatible with the organically based binder systems described above, while for another the photoreactive monomer esters would undergo hydrolytic breakdown at the high pH values.

There are however known methods by which these aqueous nanoparticle suspensions can be converted into organically based, alkali-free, alcohol-compatible nanoparticle suspensions. For example, in accordance with EP 00569813, as described in more detail in Example 1, the aqueous nanoparticle suspensions can be converted into their protonated, alkali-free form with the aid of cation exchangers (H form).

The corresponding, SiOH-modified silica nanoparticle suspensions are compatible with protic solvents, such as alcohols, for example isopropanol (IPA), 1-methoxy-2-propanol (MOP), n-propyl glycol, n-butyl glycol, propylene glycol or diacetone alcohol (DAA). The water content can then be wholly or partially removed from the alcohol/water mixtures by distillation or by solvent exchange using ultrafiltration.

Such protonated silica nanoparticles dispersed in protic solvents are now also offered by various companies in a variety of particle sizes and in various solvents. For example, silica nanoparticles with particle sizes of 10 to 50 nm in ethylene glycol (EG), isopropanol (IPA) or methyl ethyl ketone (MEK) are commercially available from Nissan under the product name Organosilicasol®. The product types that are preferably used, obtained from Nissan under the name Organosilicasol® IPA ST, have the following properties: the particle sizes are in the range from 10 to 15 nm, the SiO₂ solids content is 30-31 wt. %, the water content is specified as <1%, the viscosity is <15 mPa·s, and the pH is in the range from 2 to 4.

Clariant offers silica nanoparticles in mono-, di- and trifunctional acrylates, such as 2-hydroxyethyl methacrylate, hexanediol diacrylate (HDDA) and trimethylol propane triacrylate (TMPTA), under the product name HILINK® Nano G, which are specifically suitable for UV- and electron beam-curing systems. The same company also offers nanosilicas in alcohols, for example in isopropanol or propyl glycol, under the product name HILINK® Nano G 502.

Under the name Nalco 1034A, NALCO also offers acidified (pH 2.8) silica particles in alcohol/water mixtures.

According to the aforementioned selection criteria, the formulations according to the invention contain high proportions of silica nanoparticles, the term “high” relating to the ratio of binder (acrylate system) to silica nanoparticles. In the coating surfaces according to the invention, this ratio is adjusted so that their concentration is such that the hydrophilic silica nanoparticles can also be detected on the coating surface, as a result of which an elevated hydrophilicity is produced in comparison to the pure binder. The corresponding hydrophilicity can readily be demonstrated by applying a drop of water. While in the case of coatings made from the pure acrylate system the contact angle of the water droplet is conventionally very steep, for example in the range from about 75 to 90°, in the case of the hydrophilic, silica nanoparticle-containing coating surfaces according to the invention, shallower water contact angles are achieved, with values of less than 45°, preferably less than 30°.

The binder/silica ratio is naturally dependent on the particle size or the specific surface area of the nanoparticles. For example, in the Nissan silica dispersion “Silica IPA ST” (particle size: 10-15 nm) which is preferably used, the acrylate/silica ratio should preferably be adjusted so that the silica content is higher than the acrylate binder content. The acrylate/silica ratio is preferably in the range of 45:55 up to a range of 25:75, particularly preferably in the range of 40:60 up to a range of 30:70.

It is also possible to combine mixtures of silica nanoparticles, for example the fine-particle Nissan particles IPA-ST (10-15 nm) with the coarser IPA-MS (17-23 nm) or IPA-ST L (40-50 nm) particles.

Component b), acrylate, generally comprises UV- or electron beam-curable, ethylene-unsaturated monomers having aliphatic or cycloaliphatic radicals. Low-molecular-weight acrylates or methacrylates having preferably fewer than 30 C atoms are particularly preferred. Examples are hexanediol diacrylate (HDDA), dipentaerythritol hexaacrylate (DPHA), tripropylene glycol diacrylate (TPGDA), pentaerythritol triacrylate (PETA), pentaerythritol tetraacrylate, neopentyl glycol diacrylate, hydroxyethyl acrylate, hydroxyethyl methacrylate (HEMA), glycidyl acrylates or methacrylates and functional silanes, such as 3-methacryloxypropyl trimethoxysilane. Mixtures of these acrylates can also be used.

As described in the examples, polyfunctional acrylates are preferably used, particularly preferably dipentaerythritol hexaacrylate (DPHA) or DPHA mixed with pentaerythritol triacrylate (PETA).

Component c), protic solvent, comprises protic solvents such as aliphatic alcohols such as e.g. ethanol, isopropanol, n-butanol, ethylene glycol, diethylene glycol, propylene glycol, ethoxyethanol, diacetone alcohol (DAA, 4-hydroxy-4-methyl-2-pentanone), 1-methoxy-2-propanol (MOP), n-propyl glycol, n-butyl glycol or mixtures of these solvents.

These solvents are generally allowed to evaporate after the substrate has been coated, prior to UV curing.

Further solvents which can be added in small amounts to the final formulation are esters or ketones, such as ethyl acetate, butyl acetate, propoxyethyl acetate, methyl ethyl ketone or methyl isobutyl ketone.

Component d), one or more photoinitiators, comprises systems which, in air or under inert gas, initiate the polymerization of the acrylate components under irradiation with UV light. Such systems, which are conventionally added in a few wt. % (approx. 2 to 10) based on the amount of acrylate used, are obtainable under the product name “Irgacure®” or Darocure®, for example. Mixtures, such as e.g. Irgacure 184/Darocure TPO, are also frequently used. Irgacure 184® is hydroxycyclohexyl phenyl ketone and Darocure TPO® is diphenyl-(2,4,6-trimethylbenzoyl) phosphine oxide.

Component e), anionic sulfur-containing surfactant, comprises in particular dioctyl sulfosuccinate sodium salt (DSSNa), CAS no. [577-11-7], which is available for example from Cytec, USA in various variants under the product name Aerosol OT (AOT). The name of the pure substance is Aerosol OT 100, while various formulations in different solvents of the same chemical species are available under the names OT-75, OT-70-PG, OT-75-PG, OT-B, GPG, OT-S and OT-TG. The pure substance is referred to below as DSSNa. The surfactant is used here in substance proportions of over 0.025%, based on the complete coating solution, preferably in proportions of between 0.05% and 0.09%, particularly preferably between 0.1% and 0.3%, based in each case on the complete coating solution. Surprisingly, the desired effects could not be achieved with non-ionic surfactants, such as Triton X 100, Span 80, Brij 35 or Pluronic L 64.

Regarding the substrates which can be further enhanced through the application of the coating formulations according to the invention, there is a wide choice of transparent, translucent and also non-transparent materials, such as ceramics, marble or wood, within the scope of the present invention. Owing to the excellent “transparent protective properties” of the novel coating systems, highly transparent substrates are naturally preferred. Transparent thermoplastic polymers consisting for example of polycarbonate (Makrolon®, Apec®) or polycarbonate blends (Makroblend®, Bayblend®), polymethyl methacrylate (Plexiglas®), polyester, cycloaliphatic olefins such as Zeonor® and glass are most particularly preferred.

Polycarbonates for the compositions according to the invention are homopolycarbonates, copolycarbonates and thermoplastic polyester carbonates.

The polycarbonates and copolycarbonates according to the invention generally have average molecular weights (weight averages) of 2000 to 200,000, preferably 3000 to 150,000, in particular 5000 to 100,000, most particularly preferably 8000 to 80,000, in particular 12,000 to 70,000 (determined by GPC with polycarbonate calibration).

With regard to the manufacture of polycarbonates for the compositions according to the invention, reference is made by way of example to “Schnell”, Chemistry and Physics of Polycarbonates, Polymer Reviews, vol. 9, Interscience Publishers, New York, London, Sydney 1964, to D. C. PREVORSEK, B. T. DEBONA and Y. KESTEN, Corporate Research Center, Allied Chemical Corporation, Moristown, N.J. 07960, “Synthesis of Poly(ester)carbonate Copolymers” in Journal of Polymer Science, Polymer Chemistry Edition, vol. 19, 75-90 (1980), to D. Freitag, U. Grigo, P. R. Müller, N. Nouvertne, BAYER AG, “Polycarbonates” in Encyclopedia of Polymer Science and Engineering, vol. 11, second edition, 1988, pages 648-718 and finally to Drs U. Crigo, K. Kircher and P. R. Müller “Polycarbonate” in Becker/Braun, Kunststoff-Handbuch, volume 3/1, Polycarbonate, Polyacetale, Polyester, Celluloseester, Carl Hanser Verlag Munich, Vienna 1992, pages 117-299. Production is preferably performed by the interfacial polycondensation process or the melt interesterification process.

Homopolycarbonates based on bisphenol A and copolycarbonates based on the monomers bisphenol A and 1,1-bis-(4-hydroxyphenyl)-3,3,5-trimethyl cyclohexane are preferred. These or other suitable bisphenol compounds are reacted with carbonic acid compounds, in particular phosgene or in the melt interesterification process diphenyl carbonate or dimethyl carbonate, with formation of the relevant polymers.

Coating additives, for example flow control agents and UV light stabilisers, such as triazoles and sterically hindered amines, can be added to the formulations as additional components.

As has already been mentioned, the formulations according to the invention can be used both as hydrophilic, abrasion-resistant or scratch-resistant coatings, i.e. as protective coatings, and as substrate layers for further coatings.

Typical film thicknesses are in the range from 0.2 to 200 μm, preferably between 1 and 50 μm, most preferably between 2 and 20 μm.

Areas of application for the abrasion-resistant or scratch-resistant highly transparent protective coatings are in areas in which glass is replaced by plastics such as polycarbonate, for example in the automotive sector, in architectural glazing or in optical areas, such as spectacle lenses. In comparison to known, conventional scratch-resistant coatings, the hydrophilic hard coat films according to the invention can have two additional advantages. They have antifogging properties, as described later in the examples, and antistatic effects. Antifogging properties can easily be demonstrated by breathing on the corresponding surfaces, where with good antifogging properties, misting due to atmospheric moisture is prevented.

The second major area of application of the hydrophilic hard coat films according to the invention is based on the fact that the surface is SiOH-functional. This allows it to be recoated or surface-modified.

This surface modification can be carried out by physical methods, such as e.g. sputtering or chemical vapor deposition (CVD), by conventional coating methods such as flow coating and by simple dipping processes, for example from aqueous solutions. The last method in particular, surface modification by dipping into aqueous formulations, is very straightforward. Thus it was found, surprisingly, that when dipped into aqueous solutions of cationic compounds the SiOH-functional coatings according to the invention can bind to these cationic compounds with high strength. These cationic compounds can be of both low and high molecular weight. Examples of low-molecular-weight, water-soluble cationic compounds are quaternary ammonium salts, for example alkylbenzyl dimethyl ammonium chloride in alcohol/water (Preventol K 80®), cationic or zwitterionic surfactants, for example cetyl pyridinium chloride or Phospholipon® 90 G or cationic dyes, such as Methylene Blue®. Examples of high-molecular-weight, water-soluble cationic compounds which can be bound to the silica-containing hard coat films from the aqueous phase are cationic polyelectrolytes, such as polyallylamine hydrochloride (PAH), polydiallyl dimethyl ammonium chloride (polyDADMC), polyethyleneimine hydrochloride or polyvinylamine hydrochloride. The surfaces of the hydrophilic hard coat films according to the invention can be modified in this way in various directions by means of simple dipping and washing processes, according to the properties of the cationic compounds. Correspondingly, the silica-containing coating surfaces according to the invention are ideally suitable for the application of self-assembled polyelectrolyte multilayers, as described for example in Current Opinion in Colloid and Interface Science 8 (2003) 86-95.

Furthermore, an object of the present invention are molded articles comprising a surface, which is coated by a composition or by a process according to the present invention.

Object of the present invention are additionally multilayered articles comprising a substrate layer which comprises at least on one side a second layer and the second layer is prepared by a composition according to the present invention. The multilayered article may comprise an additional layer prepared by cationic or zwitterionic compounds.

### EXAMPLES

### Example 1

### Conversion of Alkali-Stabilized, Aqueous Silica Nanoparticles into the Alcohol-Compatible, SiOH-Functional Modification

250 g of Lewatit S 100® (acid cation exchanger in H form) were added to 500.00 g of Levasil 300®/30% (aqueous, Na+-stabilised silica nanoparticle suspension, 30 wt. %, 300 m²/g, pH 10, H.C. Starck, Germany). The suspension was stirred for 1 hour using a magnetic stirrer and then separated from the ion exchanger by filtering through a paper filter. 100.00 g of diacetone alcohol (DAA, 4-hydroxy-4-methyl-2-pentanone) were added to the filtrate.

Water was distilled off using a rotary evaporator under a reduced pressure of approx. 15 to 20 mbar. After 300 ml of distillate had been obtained, a further 200.00 g of diacetone alcohol were added and concentration to low volume was continued in vacuo. The evaporation process, controlled by means of a solids content analysis, was continued until a 30 wt. % suspension in diacetone alcohol was obtained. The water content determined by Karl Fischer, was 3.8 wt. %.

### Example 2

### Production of a Silica Nanoparticle-Containing, UV-Curable Acrylate Formulation with an Acrylate Mixture as Binder and Surfactant DSSNa

7.0 g of dipentaerythritol penta/hexaacrylate (DPHA), 1.5 g of pentaerythritol triacrylate (PETA) and 1.5 g of tripropylene glycol diacrylate (TPGDA) were stirred in a beaker in 48.0 g of diacetone alcohol (DAA) using a magnetic stirrer, a clear solution being formed after a few minutes. 0.28 g of DSSNa were added to this solution, a clear solution being obtained by stirring. The UV initiator mixture consisting of 0.4 g of 1-hydroxycyclohexyl phenyl ketone (Irgacure 184®) and 0.1 g of diphenyl-(2,4,6-trimethyl benzoyl) phosphine oxide (Darocure TPO®) was added and stirring was continued for a further 20 minutes with exclusion of light, a clear solution being formed.

Finally 83.0 g of the 30 wt. % silica nanoparticle suspension in DAA described in Example 1 were added. Stirring was continued for a further 15 minutes with exclusion of light. The clear nanoparticle suspension was filtered through a 3 μm paper filter into a brown flask. A solids content of 25.3 wt. % was determined using a thermobalance.

### Example 3

### Coating of Polycarbonate Substrates

The suspension described in Example 2 was applied to polycarbonate substrates by flow coating. Two substrates with surface dimensions of 10×15 cm were used:

Substrate 1: Makrolon® M 2808 (bisphenol A polycarbonate: medium-viscosity bisphenol A polycarbonate, MFR 10 g/10 min in accordance with ISO 1133 at 300° C. and 1.2 kg, without UV stabilizer and mould release agent)

Substrate 2: Makrolon® A1 2647 (medium-viscosity bisphenol A polycarbonate with UV stabilizer and mould release agent; MFR 13 g/10 min in accordance with ISO 1133 at 300° C. and 1.2 kg).

In addition, for comparative purposes, the substrates were not coated and underwent the following measurement methods as comparative tests.

To this end the substrates were first cleaned with isopropanol and blown dry with ionized air. The casting solution applied by flow coating was first allowed to evaporate for 5 minutes at room temperature (RT) and then dried for 30 minutes at 80° C. The coating then underwent UV curing using an Hg lamp, being irradiated with an energy of approx. 5 J/cm².

Characterization of the dry film mass: in addition to the acrylate binder it contains 70 wt. % of silica and 0.8 wt. % of DSSNa.

The coatings were characterized by means of the following parameters:
a) Film thickness by means of a white light interferometer
   Top: 2.7 μm, middle: 3.3 μm, bottom: 4.2 μm
b) Haze by means of a hazemeter in accordance with ASTM 1003-00 on the substrate Makrolon M 2808
   A haze value of 0.25% was measured, which corresponds to an excellent transparency
c) Abrasion by means of the abrasive wheel method in accordance with DIN 53 754 (Taber test) on the substrate Makrolon M 2808
   A haze value of 9.71 was measured after 1000 cycles
d) Adhesion by means of the ASTM D 3359-02 tape test on the substrates Makrolon M 2808 and A1 2647
   The cross-hatch adhesion test produced completely smooth edges and could therefore be rated 0 in accordance with DIN EN ISO 2409. The coating on both substrates 1 and 2 thus demonstrates perfect adhesion.
e) Contact angle of water: the contact angle was determined by pipetting approx. 50 μl of water and visually estimating the corresponding angle between the substrate surface and the water droplet. The contact angle with water gives an indication of the hydrophilicity, with lower figures signifying greater hydrophilicity.
   In the case of the coating surface from Example 3, a uniform flow of the water droplet with a very shallow contact angle (approx. <20°) was determined. By contrast, in the comparative test with the uncoated substrate Makrolon® M 2808, a value of approx. 90° was measured.
f) Antifogging properties: a substrate, one half of which was coated with the silica/acrylate coating film according to the invention, was breathed upon. The uncoated section misted over and became opaque, whereas no change could be determined in the section with the hydrophilic protective film, i.e. its transparency was retained in full.

### Example 4

### Silica Nanoparticles in 1-methoxy-2-propanol (MOP)

500.0 g of Organosilicasol® IPA ST dispersion (10-15 nm silica nanoparticles, 30-31 wt. % in isopropanol, pH 2-4, water content <1%, Nissan, Japan) were evaporated in a rotary evaporator at 20-30 mbar and 30-35° C., the isopropanol (IPA) that was distilled off being replaced by 1-methoxy-2-propanol (MOP). This process was designed in such a way that a 30 wt. % silica nanoparticle dispersion in 1-methoxy-2-propanol, referred to below as SiO₂ (MOP), was obtained as the end product. This product is analogous to that of Example 1, differing only in terms of the solvent.

### Example 5

### Production of a Silica Nanoparticle-Containing UV-Curable Acrylate Formulation with DPHA as Binder and Surfactant DSSNa

10.00 g of dipentaerythritol hexaacrylate (DPHA, from Aldrich) were dissolved in 24.60 g of MOP (from KMF) in a 250 ml three-neck flask while stirring. 0.14 g of the surfactant DSSNa were added and stirring was continued until a clear solution had formed. The UV initiator mixture consisting of 0.4 g of 1-hydroxycyclohexyl phenyl ketone (Irgacure 184®) and 0.1 g of diphenyl-(2,4,6-trimethylbenzoyl) phosphine oxide (Darocure TPO®) was added and stirring was continued for a further 20 minutes with exclusion of light, a clear solution being obtained. Finally, 35.60 g of the SiO₂ (MOP) dispersion described in Example 4 were added and stirring was continued until a clear dispersion was obtained, which was filtered through a 3 μm paper filter. The dispersion was stored in dark-coloured flasks.

Characterization of the dry film mass: in addition to the acrylate binder it contains 50 wt. % of silica and 0.7 wt. % of DSSNa.

### Example 6 (Comparative Example)

### Production of a Silica Nanoparticle-Containing, UV-Curable Acrylate Formulation with DPHA as Binder and without Surfactant

The casting solution was prepared in the same way as in Example 5, but with the quantities specified in the table below (in g).

Characterization of the dry film mass: in addition to the acrylate binder it contains 50 wt % of silica but no surfactant.

### Example 7

### Comparison of Example 5 and Example 6 and Determination of the Coating Properties

The initial amounts are listed in the table for comparison:

| | Example 6 (amount in | Example 5 (amount in |
|---|---|---|
| Component | g) | g) |
| DPHA | 10.00 | 10.00 |
| Irgacure 184 | 0.40 | 0.400 |
| Darocure TPO | 0.10 | 0.10 |
| Silica sol in MOP (31%) | 35.10 | 35.60 |
| SiO₂ (MOP) from Ex. 4 | | |
| MOP | 24.40 | 24.60 |
| DSSNa | 0.00 | 0.14 |
| Total amount | 70.00 | 70.84 |

The formulations described were applied to substrates 1 and 2 as in Example 3.

The coated substrate obtained with the casting solution according to Example 5 is designated below as Example 5-1, the coated substrate obtained with the casting solution according to Example 6 is designated as Example 6-1.

The properties of Example 5-1 and Example 6-1 were determined using the measurement methods described in Example 3.

Film thickness: In both cases approx. 2.5 to 5.0 μm

Adhesion: The test was carried out by means of the cross-hatch adhesion test according to ASTM D 3359. The results were rated in accordance with DIN EN ISO 2409. ISO rating 0 means that the edges of the cut are completely smooth, no part of the coating has flaked away. Ratings of 0 (in accordance with DIN 2409) were determined in all cases.

Antifogging: In Example 5-1 only minimal misting and in Example 6-1 only slight misting were observed.

Water contact angle and abrasion (Δ haze % 1000)

| | Haze (%) | Δ Haze 1000 (%) | Contact angle |
|---|---|---|---|
| Example 5-1 | | | |
| 50 wt. % silica | 0.53 | 7.42 | Very shallow, |
| 0.7 wt. % DSSNa | | | approx. 20-25° |
| Example 6-1 | | | |
| 50 wt. % silica | 0.45 | 18.81 | Shallow, approx. |
| 0.0 wt. % DSSNa | | | 40° |

The abrasion properties were determined by comparing the haze values of the original sample with the haze after an abrasion test after 1000 cycles.

Haze: In accordance with ASTM 1003-00 using a hazemeter, as a measure of the transparency.

Δ Haze 1000 c: Haze value after 1000 cycles of the Taber test less the haze value of the original sample. The Taber test is carried out in accordance with DIN 53 754 using the abrasion wheel method with an abraser model 5151 (CS-10F Calibrase abrasion wheels with 500 g weights per wheel).

As the values show, the addition of surfactant improves both abrasion and wettability with water.

### Examples 8 and 9

### Production of a Silica Nanoparticle-Containing, UV-Curable Acrylate Formulation with DPHA as Binder, with and without Surfactant

The coating formulations were produced in the same way as in Example 5, based on the following initial amounts in g:

| | Example 8 with | Example 9 (Example 8 |
|---|---|---|
| Component | surfactant | without surfactant) |
| DPHA | 10.00 | 10.00 |
| Irgacure 184 | 0.40 | 0.40 |
| Darocure TPO | 0.10 | 0.10 |
| Silica sol in MOP (31%) | 70.60 | 69.20 |
| SiO₂ (MOP) from Ex. 4 | | |
| MOP | 20.80 | 20.20 |
| DSSNa | 0.20 | 0.00 |
| Total amount | 102.10 | 99.90 |

The coatings were applied to substrate 1 in the same way as in Example 7. The coated substrates obtained are designated Example 8-1 and 9-1

Characterisation of the dry film mass: in addition to the acrylate binder it contains 65 wt. % of silica, with and without surfactant.

The properties of Examples 8-1 and 9-1 were determined using the measurement methods described in Example 3.

Antifogging properties: In both cases no haze could be determined from breathing on the coatings.

Adhesion: In the adhesion test ratings of 0 (in accordance with DIN 2409) were established in all cases.

Haze and contact angle with water:

| | Haze (%) | Δ Haze 1000 (%) | Contact angle |
|---|---|---|---|
| Example 8-1 | | | |
| 65 wt. % silica, | 0.28 | 6.6 | Very shallow, |
| based on dry film | | | approx. <20° |
| mass | | | |
| 0.7 wt. % DSSNa | | | |
| Example 9-1 | | | |
| 65 wt. % silica, | 0.38 | 18.11 | Shallow, approx. |
| based on dry film | | | <40° |
| mass | | | |
| 0.0 wt. % DSSNa | | | |

As Examples 8-1 and 9-1 show, the addition of DSSNa had a positive influence on both abrasion (low Δ haze 1000 values) and hydrophilicity (shallow contact angle with water).

### Example 10

### Coloring the Coating with a Cationic Dye

Example 8-1 was dipped into a 0.1 wt. % aqueous solution of methylene blue (cationic dye) and rinsed with water. A uniformly intense blue coloring could be seen on the side coated with the coating.

In the comparative test the same substrate was dipped into a 0.1 wt. % solution of erioglaucin (anionic dye) and rinsed with water, with no change of color being established.

This comparison shows that the silica-containing coating surfaces according to the invention have a high, selective affinity to cationic agents.

### Example 11

### Modification of the Coating with a Quaternary Ammonium Salt

Part of the coating from Example 8-1 was dipped into a 1 wt. % solution of alkylbenzyl dimethyl ammonium chloride (Preventol® R 50) in water and rinsed with water. The sample was dried (10 minutes in a circulating air drying oven at 50° C.) and a drop of water was then applied to the section of the coating surface modified with alkylbenzyl dimethyl ammonium chloride, a very steep contact angle of approx. 90° being observed. By contrast, the section of the coating surface not modified with alkylbenzyl dimethyl ammonium chloride exhibited a very shallow contact angle (approx. <25°) with water.

The section of the coating surface modified with alkylbenzyl dimethyl ammonium chloride underwent a one-hour boiling test and was again subjected to a water contact angle test. As before the boiling test, a steep contact angle was observed. The quaternary ammonium compound was thus bound with high strength/very firmly to the silica coating surface.

### Example 12

### Modification of the Coating with a Cationic Polyelectrolyte

The coating from Example 8-1 was dipped for 10 minutes into a 0.1 wt. % solution of polyallylamine hydrochloride (PAH) in water. It was then rinsed with water and dried.

Measurement of the contact angle with water (approx. 90°) showed that the cationic polymer was bound to the coating surface. Even after boiling for one hour, the contact angle was still just as steep, which indicates a very stable bond of the cationic polyelectrolyte to the silica-containing coating surface.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composition comprising
a) colloidal silica;
b) at least one acrylate;
c) at least one protic solvent;
d) at least one photoinitiator; and
e) at least one anionic sulfur-containing surfactant.

2. Composition according to claim 1, wherein the acrylate is selected from the group consisting of monomeric acrylic acid esters, methacrylic acid esters and mixtures thereof.

3. The composition according to claim 2, wherein the acrylate is selected from the group consisting of trifunctional, tetrafunctional or hexafunctional acrylate or methacrylate compounds and mixtures thereof.

4. The composition according to claim 1, wherein the anionic sulfur-containing surfactant is dioctyl sulfosuccinate sodium salt.

5. The composition according to claim 1, wherein the content of silica in wt. % is higher than the content of acrylate.

6. The composition according to claim 1, wherein the ratio of the parts by weight of acrylate and silica is between 25:75 (acrylate:silica) and 45:55.

7. The composition according to claim 6, wherein the ratio of the parts by weight of acrylate and silica is between 30:70 (acrylate:silica) and 40:60.

8. The composition according to claim 1, wherein
a) the colloidal silica is protonated, alcohol-compatible, spherical silicon dioxide nanoparticles having a pH of from 2 to 4 and a diameter of less than 30 nm;
b) the acrylate comprises a UV- or electron beam-curable, ethylene-unsaturated low-molecular-weight acrylate or methacrylate having fewer than 30 C atoms and having aliphatic or cycloaliphatic radicals;
c) the protic solvent comprises aliphatic alcohol;
d) the photoinitiator is selected from the group consisting of hydroxycyclohexyl phenyl ketone and diphenyl-(2,4,6-trimethylbenzoyl) phosphine oxide; and
e) the anionic sulfur-containing surfactant is dioctyl sulfosuccinate sodium salt.

9. A process for producing the composition according to claim 1, comprising
i) producing a suspension containing colloidal silica;
ii) mixing the acrylate b), the photoinitiator d), the protic solvent c) and an anionic sulfur-containing surfactant e) together in the absence of light;
iii) mixing the suspension from i) and the mixture from ii) together in the absence of light.

10. The process according to claim 9, wherein the suspension i) contains 5-80 wt. % of the colloidal silica and mixture ii) contains 5-60 wt. % of acrylate, 0.01-0.8 wt. % of the anionic sulfur-containing surfactant and 0.1-10 wt. % of the photoinitiator in the protic solvent.

11. The process for coating surfaces, comprising applying the composition according to claim 1 to a surface and irradiating the composition with UV light.

12. A molded article having a surface coated with the composition according to claim 1.

13. A molded article having a surface coating containing colloidal silica, a crosslinked acrylate, a photoinitiator and an anionic sulfur-containing surfactant.

14. The process according to claim 11, wherein in a subsequent step, a cationic or zwitterionic compound is applied to the surface.

15. A multilayered article containing a substrate layer comprising a second layer made of a composition according to claim 1 on at least one side.

16. A multilayered article according to claim 15 wherein at least one layer comprises an additional layer made of cationic or zwitterionic compounds.

17. A multilayered article according to claim 15 wherein the substrate layer comprises ceramics, marble, wood, thermoplastic polymer or glass.

18. A multilayered article according to claim 17 wherein the thermoplastic polymer is transparent.

19. A multilayered article according to claim 18 wherein the polymer is selected from at least one of the group comprising polycarbonate, a polycarbonate blend, polymethylmethacrylate, polyester and cycloaliphatic olefine.
